(19) United States
(12) Patent Application Publication
(10) Pub. No.: US 2003/0035342 A1
(43) Pub. Date: Feb. 20, 2003

(54) Range measuring system

(75) Inventors: Michael Harrington, Lowell, MA (US); Eric Foxlin, Arlington, MA (US)

Correspondence Address: FISH & RICHARDSON PC, 225 FRANKLIN ST, BOSTON, MA, 02110, US

(73) Assignee: Intersense Inc, a Delaware Corporation

(21) Appl. No.: 10/210,492

(22) Filed: Aug. 1, 2002

Related U.S. Application Data
(62) Division of application No. 09/362,579, filed on Jul. 28, 1999, now abandoned.

(51) Int. Cl. G01S 3/80

(52) U.S. Cl. 367/127

(57) ABSTRACT

A system is provided having a transmitting transducer for transmitting a burst of energy in response to an electrical drive waveform. The system includes a receiving transducer for generating an electrical signal in response to arrival of the transmitted burst of energy. A generator is provided for generating the electrical drive waveform, such generator generating such waveform to enable the receiving transducer to produce the electrical signal with at least one of the following characteristics: (a) a series of waves having an amplitude which increases, then decreases, and then increases again; (b) a series of groups of waves, such series having an initial group of waves of a period, T, followed by a transitional group having at least one wave with a period different from the period, T, followed by a succeeding group of waves having the period, T; or (c) a series of groups of waves, such series having an initial group of waves and a later group of waves, the later group of waves having a phase shift of 2πn relative to the initial group of waves, where n is a non-integer number. A detector is provided for detecting one of the characteristics of the electrical signal generated by the receiving transducer. The detector uniquely detects a specific point in the generated signal, such point being unambiguously identifiable because of the characteristic in the electrical signal generated by the receiving transducer.

### BACKGROUND OF THE INVENTION

This invention relates generally to range measuring systems and more particularly to range measuring systems wherein range is determined by measuring the time of arrival of wave energy.

As is known in the art, range measuring systems have a wide range of applications. One such system includes a transmitter for transmitting a pulse of wave energy, such as a radar or sonar pulse, directing such pulse towards an object, detecting a reflection by the object of such pulse, measuring the time of arrival of the detected reflection, and determining the range to the object from such measured time of arrival. In this case, called pulse-echo mode, the range is calculated as half the round-trip travel time, times the speed of propagation. In other systems called transmit-receive mode, the range to the actual source of the wave energy itself is detected.

Referring to FIG. 1, a system 10 is shown for determining range, or distance, from a transmitter 12 of wave energy to a receiver 14. The range measurement may correspond to a direct path between a spatially separated source and receiver, or to half the roundtrip path from a transmitter to a reflecting object and back to a receiver. The transmitter 12 here transmits a burst of sound wave energy in response to a trigger signal. Here, the trigger pulse is generated by a computer or microprocessor processing unit (MPU) 16 in detector 20, and is fed to a pulse generator 18. In response to the trigger signal, the pulse generator 18 produces a burst of signal, here a train of electrical waves, here bipolar pulses, used to drive the transmitter 12, in this case an ultrasonic speaker. More particularly, here in this example, the burst fed to the speaker 12 is a train of six waves having a frequency of 40 KHz, as shown in FIG. 2A. Thus, here the burst is 0.15 milliseconds in duration. More particularly, the waves shown in FIG. 2A and used to drive the speaker 12 are oscillatory having a level which swings between a positive level (+) and a negative value (−) within a period T, here T is 0.025 milliseconds. The waves are here, for example, fed as a voltage to a piezoelectric transducer of the speaker 12, such voltage alternating between +6 volts and −6 volts within the period T. The speaker 18 is a resonant structure having a resonant frequency f=(1/T), (i.e., f=40 KHz), and a Q greater than 1 and typically between 10 and 50, here the Q is 25, where Q is the resonant frequency divided by the 3 db bandwidth of the resonant structure.

In response to the drive signal shown in FIG. 2A, the speaker 18 produces a corresponding burst of ultrasonic wave energy having a frequency of here 40 KHz. The waveform, (i.e., the burst 19 of sound energy), produced by the speaker 18 is shown in FIG. 2B. It is noted that the envelope shown by the dotted line 23 (i.e., the envelope of the peaks in the waveform) of the burst 19 increases from a zero level monotonically during a leading edge portion 22 to a maximum level 25 after about 0.15 milliseconds, and then decreases back to zero during a trailing edge portion 24 of the burst 19. More particularly, the waveform produced by the speaker is oscillatory having a series of peaks 27 which increase monotonically until they reach a maximum 25 (which occurs when the driving train of pulses ceases) and then the peaks 27 decrease, as indicated. Multipath reflections or interference may cause additional maximum and minimum in the envelope, but in their absence the increasing and decreasing portions of the envelope are monotonic.

The burst 19 of sound wave energy is transmitted omni-directionally or in a beam with some non-zero width and is received by receiver 14 (FIG. 1) in the path of the transmitted sound waves. Here, it is desired to determine the range to the receiver. Thus, here it is desired to measure the direct path range between the speaker 12 and the receiver 14, here an ultrasonic microphone. The waveform produced by the microphone 14 in response the received ultrasonic wave is shown in FIG. 2C to be oscillatory having a series of peaks 33 and valleys 35 which increase monotonically until they reach a maximum whose amplitude decreases with range to the microphone. Subsequently, the peaks 33 and valleys 35 decrease, as indicated.

One system used to measure the range is described in U.S. Pat. No. 5,280,457, issued Jan. 18, 1994, and entitled Position Detection System and Method. Such U.S. Patent describes the use of a peak detector to detect the peak of the wave energy and from the detected peak, the time of arrival of the wave energy. In such system, the peak of the wave energy is determined using a differentiator circuit. Another system is described in U.S. Pat. No. 5,142,506, issued Aug. 25, 1992 and entitled Ultrasonic Position Locating Method and Apparatus Therefor.

A goal of many of the systems and methods in the prior art is to identify a particular cycle or half-cycle from the group of waves received by the receiver. Once this is done, a method may be employed to pick out a particular point in this cycle, usually a zero-crossing or a peak. This point within the cycle is easily identified with very good resolution—a small fraction of the wavelength. Thus, if the correct cycle has been identified, the range measurement has been made with excellent accuracy, often a fraction of a millimeter.

Many methods have been described in the prior art for identifying a particular cycle in the received wave burst, but all of them fail to pick the correct cycle under certain circumstances, resulting in a ranging error of one full wavelength or more. Many approaches rely on finding the cycle nearest to the overall peak of the burst, or the first peak smaller than a previous peak (for example U.S. Pat. Nos. 5,280,457 and 3,824,464 and 4,022,058 and 4,933,915 and 5,260,910). Unfortunately, the peak of the envelope is relatively broad, containing several cycles of nearly the same amplitude. Thus, the largest individual cycle peak is only slightly greater in amplitude than its neighbors. Therefore, a slight perturbation of the signal due to noise or the addition of a multipath reflected copy of the signal to the direct path signal can shift the location of the apparent envelope peak or cause the identification of the wrong cycle.

U.S. Pat. No. 5,142,506 discloses a different method for identifying a particular cycle in the burst. Rather than the largest cycle in the burst, it identifies the second cycle, which differs in amplitude from its neighbors much more because it is on the steep part of the rising flank of the burst. The second cycle is identified on the basis of its amplitude, which should be approximately equal to the amplitude of the second cycle in the just previous burst. A circuit is disclosed to set a threshold for the detection of the second cycle by using a peak-hold circuit to hold the peak voltage from the previous burst, with a certain decay rate adjusted to decline to a value a certain margin below the second cycle peak voltage during the time interval between successive bursts. This method improves upon the amplitude ambiguity near the peak of the burst envelope, but it provides a range measurement process which is dependant on the integrity of the burst prior to the one currently being used. Therefore, it is impossible to make independent single-shot measurements. In fact measurements must be repeated at a fixed repetition rate, and if any particular ranging cycle is corrupted by noise or occlusion, the following cycle will also be invalid.

### SUMMARY OF THE INVENTION

In accordance with the invention, a system is provided having a transmitting transducer for transmitting a burst of energy in response to an electrical drive waveform. The system includes a receiving transducer for generating an electrical signal in response to arrival of the transmitted burst of energy. A generator is provided for generating the electrical drive waveform, such generator generating such waveform to enable the receiving transducer to produce the electrical signal with at least one of the following identifying characteristics: (a) a series of waves having an amplitude which increases, then decreases, and then increases again; (b) a series of groups of waves, such series having an initial group of waves of a period, T, followed by a transitional group having at least one wave with a period different from the period, T, followed by a succeeding group of waves having the period, T; or (c) a series of groups of waves, such series having an initial group of waves and a later group of waves, the later group of waves having a phase shift of 2πn relative to the initial group of waves, where n is a non-integer number.

In accordance with one embodiment of the invention, a detector is provided for detecting one of the characteristics of the electrical signal generated by the receiving transducer.

In accordance with one embodiment, the system includes a detector for uniquely detecting a specific point in the generated signal, such point being unambiguously identifiable because of the identifying characteristic in the electrical signal generated by the receiving transducer.

In accordance with one embodiment, the specific point identified by the detector is one of: (a) a specific identifiable positive or negative peak in the electrical signal generated by the receiving transducer; (b) a zero-crossing point immediately following the identifiable peak; or (c) another peak or zero-crossing point lying approximately a predetermined time before, or after, the peak or point of (a) or (b), respectively.

In one embodiment, the specific identifiable peak is identified on the basis of amplitude relative to the amplitude of one or more preceding peaks or zero-crossings. In one embodiment, the specific identifiable peak is identified on the basis of its phase relative to the phase of one or more peaks or zero-crossings. In one embodiment, the identified peak is the first peak following a depression to have an amplitude greater than the largest peak before the depression.

In accordance with another aspect of the invention, a system is provided for detecting a burst of ultrasonic energy. The system includes a transmitter for transmitting the burst of ultrasonic energy. The transmitter is driven with a series of waves, one of the waves having a characteristic different from another one of the waves. A receiver is provided for receiving the transmitted burst of ultrasonic energy, such received energy having a characteristic therein resulting from one of the driving waves having the characteristic different from another one of the driving waves. A detector is provided for detecting the characteristic in the received energy resulting from one of the driving waves having the characteristic different from another one of the driving waves.

In accordance with another aspect of the invention, a system is provided for detecting a burst of ultrasonic energy. The system drives an acoustic transmitter with a series of waves, one of the waves in the series a phase reversal relative to a preceding one of the waves. A receiver is provided for receiving the transmitted burst of ultrasonic energy and for producing a corresponding signal having a characteristic therein resulting from the phase reversal in the driving waves. A detector is provided for detecting the characteristic in the receiver produced signal resulting from the phase reversal of the driving waves.

In accordance with another aspect of the invention, a system is provided for detecting a burst of ultrasonic energy. The system drives an acoustic transmitter with a series of waves, one of the waves in the series a phase reversal relative to a preceding one of the waves. A receiver is provided for receiving the transmitted burst of ultrasonic energy and for producing a signal having an oscillatory waveform with a series of peaks and valleys, such peaks initially increasing, then deceasing, then again increasing to a maximum. A detector is provided for detecting the decrease and subsequent increase in the series of peaks in the receiver produced signal.

In accordance with another aspect of the invention, a system is provided for detecting a burst of ultrasonic energy. The system drives an acoustic transmitter having a resonant frequency f with a pair of drive waves each having a time duration 1/f, one of the drive waves being out of phase with the other one of the drive waves. The transmitter, in response to the drive, emits a burst of oscillatory ultrasonic energy. A receiver is provided for receiving the transmitted burst and for producing in response thereto a signal having a depression therein between commencement of the received burst and a maximum in the receiver produced signal. A detector is provided for detecting the depression in the receiver produced signal.

In accordance with another aspect of the invention, a system is provided for detecting a burst of ultrasonic energy. The system drives an acoustic transmitter with a series of waves, one of the waves in the series having half period delay from the preceding wave in the series. The transmitter, in response to the drive burst, emits a burst of ultrasonic energy. A receiver is provided to receive the emitted burst. The receiver producing a signal having an oscillatory waveform comprising a series of peaks and valleys, such peaks initially monotonically increasing, then deceasing, then again monotonically increasing to a maximum. A detector is provided for detecting the decrease in the series of peaks in the receiver produced signal.

In accordance with still another feature of the invention, a system is provided for detecting an oscillatory wave energy. The system includes a transmitter for transmitting a burst of oscillatory wave energy in response to a trigger signal, such burst of oscillatory wave energy being transmitted as a series of peaks and valleys. A receiver is provided for producing a signal in response to the received burst, such signal having peaks initially monotonically increasing, then deceasing, then again monotonically increasing to a maximum. A detector is provided for detecting the decrease in the series of peaks in the receiver produced signal.

In accordance with yet another feature of the invention, a system is provided for detecting a burst of wave energy. The system includes a transmitter for transmitting a burst of wave energy in response to a trigger signal, such transmitted energy being oscillatory and having a phase reversal therein and a detector for a phase reversal in the received burst.

In accordance with another feature of the invention, a method is provided for determining a time of arrival of an oscillatory waveform, such waveform possibly being attenuated as such waveform passes through a medium, such medium maintaining the shape of the waveform. The method includes: transmitting the waveform with a phase reversal therein; receiving the transmitted waveform; detecting a phase reversal in the received waveform; and determining the time between the time the waveform was transmitted and the time the phase reversal was detected.

In accordance with another feature of the invention, a system is provided for detecting a sound burst. The system includes a microphone for receiving the sound burst and a detector fed by the microphone for detecting a phase reversal in the sound burst received by the microphone.

In accordance with another feature of the invention, a system is provided for detecting a sound burst. The system includes: an emitter for producing the sound burst with a phase reversal therein; a microphone for receiving the sound burst; and, a detector fed by the microphone for detecting the phase reversal in the sound burst received by the microphone.

In accordance with another feature of the invention, a method for detecting a sound burst includes: transmitting the sound burst with a phase reversal therein; and receiving the sound burst; and, detecting a phase reversal in the sound burst.

With such system and method, more accurate and robust detection of the received waveform is achieved.

The current invention provides a robust method of identifying a particular cycle within the burst in an independent measurement cycle. The cycle which is selected has an extremely distinct amplitude easily differentiated from its neighbors, and as a further check it has a unique phase signature as well.

Thus, one advantage of the inventive method is determination of a certain cycle within a burst of cycles, without reliance on any stored state from previous range measurements. This allows the system to be used for aperiodic ranging applications.

A second advantage of the inventive method is determination of a certain cycle with less risk of mistakenly identifying one of the neighboring cycles. This property results from the greater amplitude differentiation of the selected cycle, compared to prior art methods, which results from the use of a special modified drive waveform.

A third advantage of the inventive method is an ability to perform range measurements between transducers with greater misalignment angles relative to the sound path. These off-axis measurements have been observed to shift the relative amplitudes of the cycles within the burst (or equivalently, alter the shape of the envelope). In the inventive method, there is greater margin for the distortion of relative amplitudes, because the selected cycle differs from its neighbors by a greater margin.

A fourth advantage of the inventive method is the option to perform a “double check” on the selection of the correct cycle by using both amplitude and phase information. Alternatively, the receiver may assign a “level of confidence” to the detected time-of-arrival measurement, based on the degree of agreement between the amplitude-based and phase-based cycle selections, and/or using the degree of agreement between measured amplitude ratios of the peaks of several neighboring cycles and the expected ratios.

A fifth advantage of the inventive method is the ability to distinguish between the reception of a true system-generated burst of waves and an undesired burst of waves resulting from other interfering acoustic generators in the environment, such as machinery or banging objects. The bursts coming from the transmitting transducer will have the special characteristic envelope and phase reversal, while naturally occurring noises will rarely, if ever, have a similar pattern.

Further advantages of the invention will be apparent to one skilled in the art.

### BRIEF DESCRIPTION OF THE DRAWING

Other features of the invention, as well as the invention itself, will become more readily apparent from the following detailed description when taken together with the accompanying drawings, in which:

FIG. 1 is a block diagram of a range measuring system according to the PRIOR ART;

FIG. 2A is a waveform used to drive a transmitter in the system of FIG. 1 according to the PRIOR ART;

FIG. 2B is a waveform according to the PRIOR ART produced by the transmitter in response to the driving waveform of FIG. 2A;

FIG. 2C is a waveform according to the PRIOR ART produced by a receiver of the system of FIG. 1;

FIG. 3 is block diagram of a range measuring system according to the invention;

FIG. 4A is a waveform used to drive a transmitter of the system of FIG. 3;

FIG. 4B is a waveform produced by the transmitter in response to the driving waveform of FIG. 4A;

FIG. 4C is a waveform produced by a receiver of the system of FIG. 3;

FIG. 4D is waveform produced by a peak-hold circuit used in the receiver of the system of FIG. 3 after a delay, a schematic diagram of the peak-hold circuit being shown in FIG. 5 along with the waveform of FIG. 4C, here shown dotted;

FIG. 4E is a waveform produced by a comparator circuit used in the receiver of the system of FIG. 3;

FIG. 5 is the schematic diagram of the peak-hold circuit used in the receiver of the system of FIG. 3; and

FIG. 6 is a flow diagram of the operation of a microprocessor used in the system of FIG. 3.

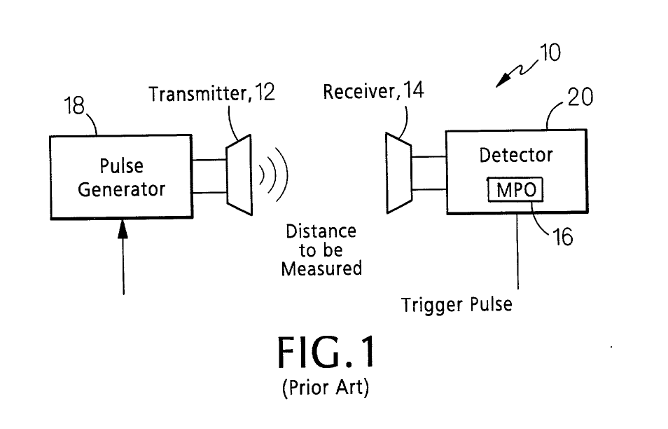

### DESCRIPTION OF THE PREFERRED EMBODIMENTS

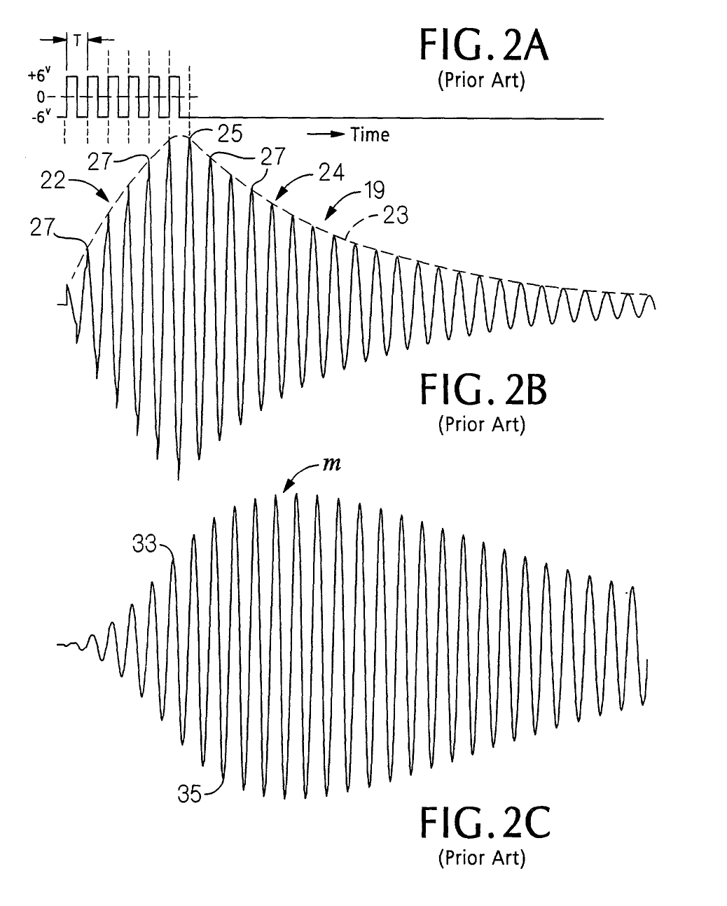

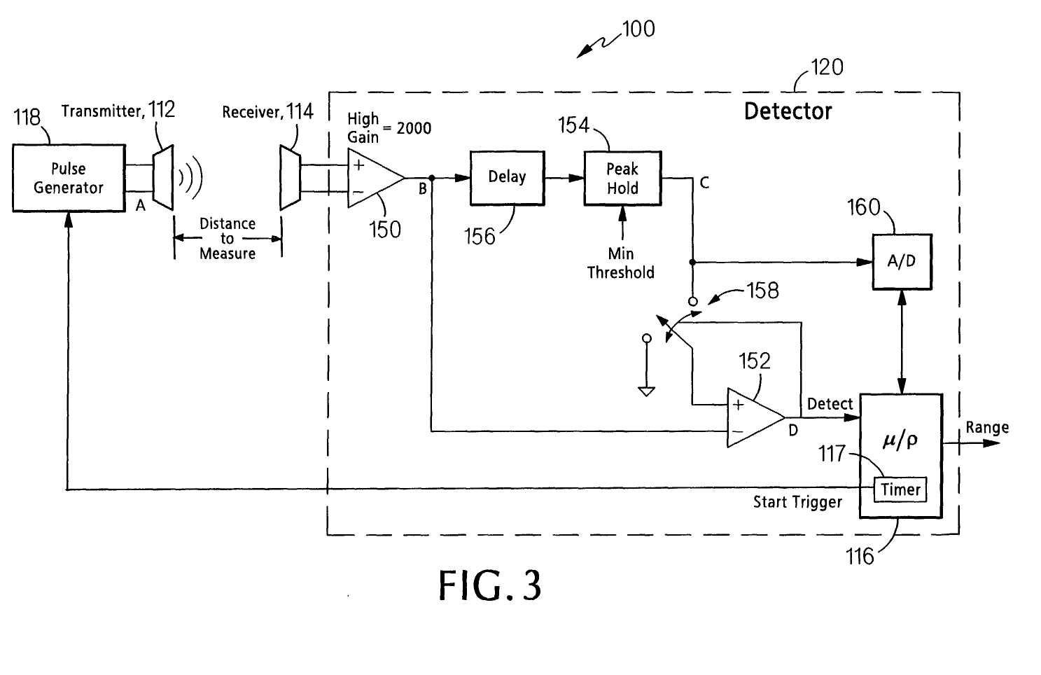

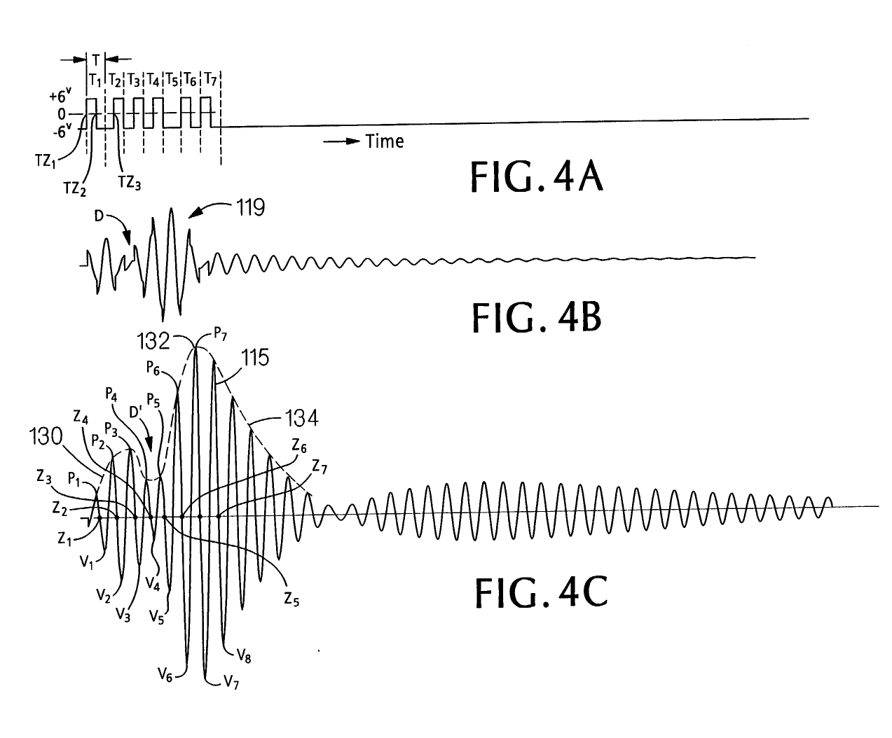

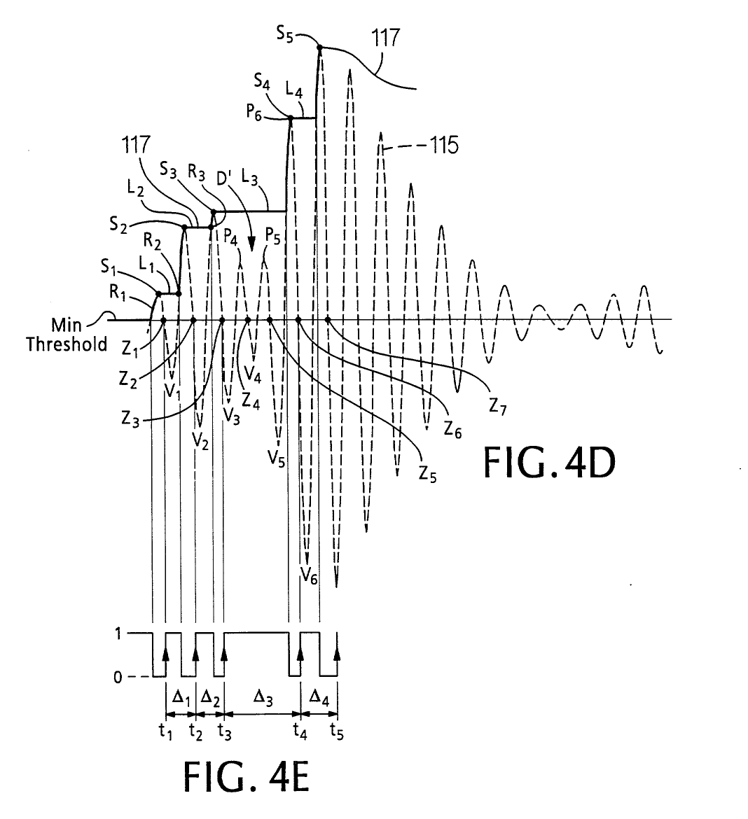

Referring now to FIG. 3, a system 100 is shown for determining range from a transmitter 112 of wave energy to a receiver 114. The range measurement here corresponds to a direct path between a spatially separated transmitter 112 and receiver 114. The transmitter 112 here transmits a burst of sound wave energy in response to a trigger signal. Here, the trigger pulse is generated by a computer or microprocessor processing unit (MPU) 116 in detector 120. Here, the trigger pulse is fed to a pulse generator 118. In response to the trigger signal, the pulse generator 118 produces a burst of signal, here a train of electrical pulses used to drive the transmitter 112, in this case an ultrasonic speaker. Here, the burst of electrical waves, are bi-polar pulses and are fed to the speaker 118 in a train of six waves having a frequency of 40 KHz, as shown in FIG. 4A. Thus, here the burst is 0.15 milliseconds in duration. More particularly, the waves shown in FIG. 4A and used to drive the speaker 112 are oscillatory having a level which swings between a positive level (+) and a negative value (−) within a period T, here T is 0.025 milliseconds. The waves are here, for example, fed as a voltage to a piezoelectric transducer of the speaker 112, such voltage alternating between +6 volts and −6 volts within the period T. The speaker 112 is a resonant structure having a resonant frequency 1/T, i.e., 40 KHz and a Q here, for example, greater than 10 and typically between 10 and 50, here the Q is 25. Here, however, unlike the waveform described above in connection with FIG. 2A, the waveform of FIG. 4A has a phase change in it; here, the phase change is a 180 degree phase change, i.e., a phase reversal, after the first period, T₁. More particularly, while during each of the six periods T₁-T₆ of the waveform shown in FIG. 2A, the oscillation used to drive the speaker 18 during the each of the six periods T₁-T₆ begins at a positive (+), changes to a negative (−) value after a half period, T/2, and remains at the negative (−) value for the last half of the period, during the first period, T₁, the waveform shown in FIG. 4A also begins at a positive value (+), changes to a negative value (−) after the first half period, T/2, and remains at the negative (−) value for the last half of the period T₁, the next pulse produced during period T₂ begins at the negative value (−), changes to the positive value (+) after the first half period, T/2, and remains at the positive (+) value for the last half of the period T₂. Thus, the second pulse (i.e., the pulse or wave produced during the period of time T₂) is 180 degrees out of phase with the first pulse (i.e., the pulse or wave produced during period of time T₁); i.e., there has been a phase reversal in the oscillatory waveform used to drive the speaker 112. The pulses or waves produced during periods T₃ and T₄ are in-phase with the pulse or wave produced during period T₂. There is an absence of a pulse or wave during period T₅. The pulses, or waves, produced during periods T₆ and T₇ are both in-phase with the pulse or wave produced during the period T₁ (i.e., the pulses, or waves, produced during periods T₆ and T₇ are both 180 degrees out of phase with the pulses or waves produced during periods T₂, T₃, T₄. Thus, the driving signal includes a series of waves, one of the waves, here the wave produced during period T₂, having a characteristic, here a phase characteristic, different from the preceding wave (i.e., the wave produced during period T₁).

It should be noted that during the period T₅, a second phase reversal is applied to the drive waveform. This phase reversal is introduced only to dampen out extra energy in the trailing portion of the burst, after the main portion. This damping technique is well known in the art and must not be confused with the phase reversal of the invention, i.e., the time reversal at time T₂, which is introduced in the first half of the drive waveform for the purpose of creating a distinct detectable pattern, or characteristic, in the received waveform.

It should also be noted that the driving function shown in FIG. 4A may be a sinusoidal, or saw-tooth, or other such waveform having the characteristics described above. It is noted that the waveform used to drive the speaker 112 has the following characteristic: A waveform varying between a pair of levels, here between +6 volts and −6 volts. The waveform has a sequence of crossings through a reference level, such reference level being the mean of the pair of levels. Thus, here the crossings are zero crossing through a zero volts reference level. The time duration between one successive pair of the crossings (here, referring to FIG. 4A, the time duration between the zero crossings of the pulse or wave produced during time period T₁ (i.e., the time duration between T_{Z1} and T_{Z2}, here T/2), is different from the time duration between a different successive pair of the crossings (here, the time duration between the zero crossings of the pulse or wave produced during time period T₂ (i.e, the time duration between T_{Z2} and T_{Z3}, here T)

In response to this burst of pulses, or waves, used to drive the speaker 112, the speaker produces a corresponding burst of ultrasonic wave energy having a frequency of here 40 KHz. The waveform (i.e., the burst 119 of sound energy) produced by the speaker 112 is shown in FIG. 4B. It is noted that the phase reversal in the drive the speaker 112 acts to dampen, or depress the oscillation produced by the speaker 112 at the depression point D of the phase reversal.

The burst 119 of sound wave energy is transmitted omni-directionally or in a beam with some non-zero width and is received by receiver 114 (FIG. 3). Here, it is desired to determine the range to a desired sound wave source, i.e., the speaker 112 and the receiver 114, here an ultrasonic microphone. The transmitter 112, as noted above, produces the burst of energy (FIG. 3B) with a depression, D, therein resulting from the phase reversal in the waveform used to drive the transmitter 112 (FIG. 4A).

The burst of transmitted energy is received by a receiving transducer, here a microphone 114. The microphone 114 is a resonant structure having a resonant frequency f, here 40 KHz. Therefore, the microphone 114 produces a signal in response to the receiver burst of energy. The signal produced by the microphone 114, shown in FIG. 4C, also has a depression, D′, therein. More particularly, the microphone 114 produced signal has a monotonically rising portion, 130 followed by a non-monotonically rising portion (i.e., the depression, D′, caused by the phase reversal in the transmitter's driving waveform), followed by a maximum portion (i.e., waveform maximum 132), followed by a decreasing termination portion 134. To put it another way, the microphone 114 produced signal is oscillatory having series of peaks P₁-P₇ . . . and valleys V₁-V₈ . . . with zero crossings Z₁-Z₇ following the peaks P₁-P₇. It is also noted that the microphone 114 produced signal has a phase reversal therein in the depression D′ corresponding to the phase reversal in the transmitter's driving waveform.

It is noted that the signal shown in FIG. 4C has the following characteristics: (a) a series of waves having an amplitude which increases, then decreases, and then increases again; (b) a series of groups of waves, such series having an initial group of waves of a period, T, (i.e., the group of waves prior to the depression D′) followed by a transitional group having at least one wave with a period different from the period, T, (i.e, the group of waves during the depression, D′) followed by a succeeding group of waves having the period, T; or (c) a series of groups of waves, such series having an initial group of waves (i.e., the group of waves prior to the depression D′) and a later group of waves (i.e, the group of waves following the depression, D′, the later group of waves having a phase shift of 2πn relative to the initial group of waves, where n is a non-integer number. That is, the period of the zero-crossing Z₁, Z₂, and Z₃ is T (i.e., Δ₁=T) and the time duration Δ₂ between the zero crossing Z₃ and the zero crossing Z₆ is a non-integer multiple of T. It is further noted that the waves after the zero crossing at Z₆ are periodic and have the period T.

A detector 120 (FIG. 3) is provided for detecting the depression, D′, in the microphone 114 produced signal (FIG. 4C). More particularly, the detector 120 detects the time of occurrence of the zero crossing Z₆ after the trigger sent to the pulse generator, i.e., the time between the trigger and the time of the first zero crossing after the occurrence of the first peak P₆ following the depression D′. This time, minus a constant offset, is a measure of the time of arrival of the received waveform and is proportional to the range between the source and the receiver, the proportionality constant being the speed of sound in the media through which the transmitted wave passes. For improved accuracy in a reflective environment, an earlier zero-crossing may be used as the time of arrival point by selecting a zero-crossing that occurred approximately a predetermined time interval prior to Z₆.

More particularly, the output of the microphone 114 is fed to a high gain amplifier 150, here having a gain of about 2000. The output of the amplifier 150 is fed to the inverting (−) input of a comparator 152 and to the non-inverting (+) input of the comparator 152 through a delay 156, peak-hold circuit 154, and switch 158, as indicated. The output of the delay is fed to an analog to digital (A/D) converter 160 with the corresponding digital representation of the delay 156 output being fed to the microprocessor 116, as indicated. The switch 158 is coupled to either the output of the delay 156 or to a reference potential (here ground, representative of the zero crossings of the oscillatory received waveform shown in FIG. 4C) selectively in accordance with the output of the comparator 152. The arrangement is designed to detect each peak in the received waveform and to then identify the zero crossing after such detected peak. More particularly, the microprocessor 116 is fed by the output of the comparator and time stamps each zero cross detected after the received waveform exceeds the last detected (and held) peak. Thus, if the time between detected zero crossings exceeds the period, T, the microprocessor 116 indicates that a depression, D′, has occurred in the peaks of the received waveform. Thus, the microprocessor 116 identifies this event as reception of the received waveform and the time stamp of this zero crossing is used to determine the range corresponding to the time duration between the initiation of the transmitted sonic waveform and the time of this zero crossing.

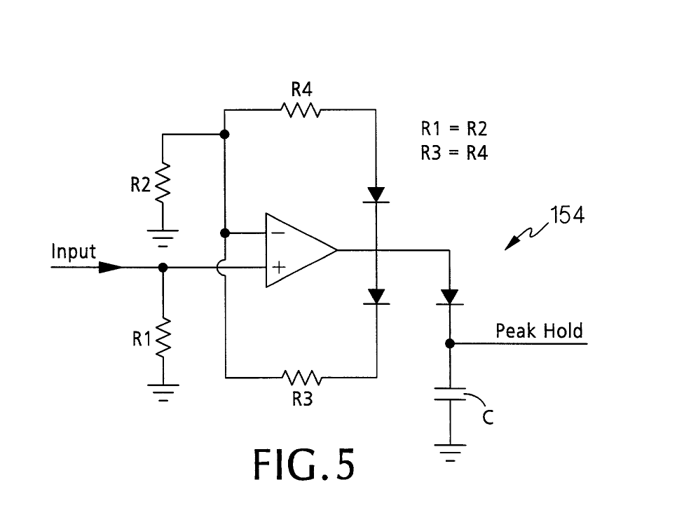

The received sonic waveform 115 is, as noted above, fed to the peak-hold circuit 154. The peak hold circuit 154, shown in FIG. 5, follows the level of the received waveform as such level rises and holds the level on a capacitor C when the level of the waveform falls. Referring to FIG. 4D, and considering the received waveform 115 (FIG. 4C) shown in dotted in FIG. 4D, the peak-hold circuit 154 products the output signal 117, shown by the solid curve in FIG. 4D. More particularly, the peak-hold circuit 154 holds the level L₁ of the received waveform at point S₁ after which the level of the received waveform falls, passes through zero crossing Z₁ to valley V₁, rises again exceeding the level L₁ held by the peak-hold 154 to point S₂. The received waveform then falls, but the peak-hold circuit 154 retains (i.e., the capacitor, C, thereof stores) the level L₂ of the received waveform at point S₂. After passing point S₂, the received waveform falls, passes through zero crossing Z₂ to valley V₂, rises again exceeding the level L₂ held by the peak-hold circuit 154 to point S₃. The received waveform then falls, but the peak-hold circuit 154 retains (i.e., the capacitor, C, thereof stores) the level L₃ of the received waveform at point S₃. After passing point S₃, the received waveform falls, passes through zero crossing Z₃ to valley V₃, rises again to peak P₄. The peak P₄ is in the depression D′ and is a level less than the level L₃ at S₃ held by the capacitor of the peak-hold circuit 154. Thus, the capacitor, C, of the peak-hold circuit 154 retains the level L₃ at point S₃ while the level of the received waveform passes through zero crossing Z₄ to valley V₄, peaks again at peak P₅, which is in the depression D′, and at a level less than the level L₃ at point S₃ which is still stored by the capacitor, C, in the peak-hold circuit 154. After hitting peak P₅ the received waveform passes zero crossing Z₅ to valley V₅, and subsequently passes through the level L₃ stored by the capacitor of the peak-hold circuit 154 at point S₃ as the received waveform rises to peak P₆ at point S₄. Thus, at point S₄ the level of the received waveform has exceeded that last held level L₃ held by the peak-hold circuit 154 thereby indicating that the received waveform has passed through the depression D′. After hitting the peak P₆, the received waveform passes through the zero crossing Z₆ to valley V₆, then rises and passes through the level held L₄ by the peak-hold circuit 154 at point S₅. The level L₄ held by the peak-hold circuit 154 now increases to the level L₅ of the received waveform at point S₅ and the received waveform then reaches the maximum peak P₇.

As noted above, the levels, L₁, L₂, L₃, L₄ held by the capacitor, C, of the peak-hold circuit 154 are passed, after delay 156, through the A/D converter 160 (FIG. 3) to the microprocessor 116. Also fed to the microprocessor 160 is the output of the comparator 152.

More particularly, the output of the comparator 152, shown in FIG. 4E, is initially “high” (e.g., logic 1). The received waveform reaches its first peak at pint S₁ and the capacitor, C, in peak-hold circuit 154 stores the level, L₁. The output of the comparator goes “low” when the received waveform 115 exceeds the last threshold peak stored by the capacitor, C, in the peak-hold circuit 154 after a short delay, Δ, here about T/8 or when waveform 115 exceeds a minimum threshold. Thus, the output of the comparator 152 goes “low” when the received waveform 115 reaches point R₁. When the output of the comparator 152 goes “low” the input to the non-inverting input (+) to the comparator 152 switches from the output of the delay 156 to the zero reference level. Thus, when the received waveform crosses the now zero threshold level, Z₁, the output of the comparator goes “high”, here at time t₁ after the trigger to the pulse generator 118 and the switch 158 couples the output of the delay 156 to the non-inverting input of comparator 152.

The output of the comparator 152 goes “low” when the received waveform 115 reaches point R₂. When the output of the comparator 152 goes “low” the input to the non-inverting input (+) to the comparator 152 switches from the output of the delay 156 to the zero reference level. Thus, when the received waveform crosses the now zero threshold level, Z₂, the output of the comparator 152 goes “high”, here at time t₃ after the trigger to the pulse generator 118 and the switch 158 couples the output of the delay 156 to the non-inverting input of comparator 152.

In response to the rising edges, a time stamp is provided by the microprocessor. If the time duration between successive zero crossing is greater than the time period T, here 25 microseconds, the depression, D′, is detected in the received waveform. Thus, the times t₁, t₂, t₃, t₄, t₅ of the zero crossing Z₁, Z₂, Z₃, Z₆, Z₇ which occur after the peaks at points S₁, S₂, S₃, S₄, S₅ are time stamped. The difference in the time, Δ, of occurrences of these zero crossings, i.e., Δ₁=t₂−t₁ and Δ₂=t₃−t₂ are calculated by the microprocessor. When the first calculated time difference Δ exceeds the period T, the depression D′ has been detected. Here, in FIG. 4D, the time difference Δ₃ is the first Δ to exceed T. Thus, the time t₃ is the time of reception of the received sound wave and the range is the speed of sound times t₄. It is noted that an offset range, R_{OS}, may be needed to account for the delay of here 2Δ₁ plus Δ₃. Such offset range, R_{OS}, may be determined by a calibration phase during which the actual range is measured and then such offset range R_{OS} (corresponding to the delay of here 2Δ₁ plus Δ₃) is subtracted from t₃ times the speed of sound.

In view of the foregoing, it is noted that the detector 120 thus uniquely detects a specific point in the signal produced by the receiver 114. The point is unambiguously identifiable because of the characteristic in the signal generated by the receiver 114. More particularly, the detector detects at least one of the following characteristics: (a) a specific identifiable positive peak or negative peak (valley) in the electrical signal generated by the receiving transducer; (b) a zero-crossing point immediately following the identifiable peak; or (c) another peak or zero-crossing point lying approximately a predetermined time before, or after, the peak or point of (a) or (b), respectively. In the embodiment just described, the specific identifiable peak is identified on the basis of amplitude relative to the amplitude of one or more preceding peaks or zero-crossings. The identified peak is the first peak following a depression to have an amplitude greater than the largest peak before the depression. In another embodiment, the specific identifiable peak is identified on the basis of its phase relative to the phase of one or more peaks or zero-crossings.

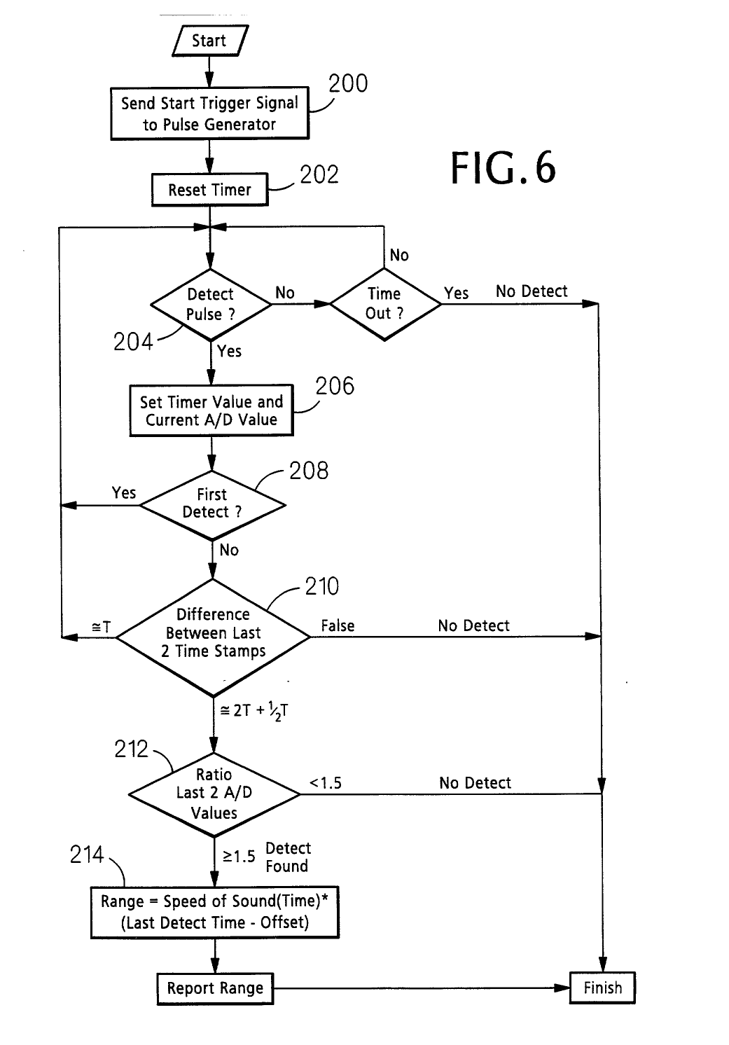

Referring now to FIG. 6, the operation of the microprocessor 116 is shown. The microprocessor 116 sends a trigger signal to the pulse generator 118 (Step 200). The trigger initiates the drive signal shown in FIG. 3A and resets and then starts the timer 117 in the microprocessor 116 (Step 302). The microprocessor 118 then determines whether a pulse has been detected (Step 204), i.e., whether the comparator 152 output has changed from a “low” to a “high” state (i.e., a rising edge has been produced, as shown in FIG. 4E). If a pulse has been detected, the detected pulse is tagged with the time value (i.e., time stamped), here t₁ (FIG. 4E) of the timer in the microprocessor 116 and the current A/D 160 converter output, here L₁ in FIG. 4D, is stored in a memory located in the microprocessor 116 (Step 206). If this is the first detected pulse, the process repeats (Step 208). Upon detection of the next pulse, such second pulse is tagged with the time of the timer, here t₂, in the microprocessor 116 and the A/D converts output, here L₂, is stored in the memory. Further, the difference in the tagged times t₂−t₁=Δ₁ is determined to determine whether the two detected pulses have a time difference approximately equal to the period of time, T. Thus, here, Δ₁, is about equal to T. If so, the process repeats (Step 210); otherwise, the process terminates since a depression has been detected. Here, the process repeats. The next pulse at t₃ is time stamped. Further, the level L₃ is stored in the memory and the difference in time Δ₂=t₃−t₂ is determined. Thus, here, Δ₂ is about equal to T. Thus, here the process repeats. The next pulse at time t₄ is time stamped. Further, the level L₄ is stored in the memory and the difference in time Δ₃=t₄−t₃ is determined. Here, Δ₃ is greater than T, here equal to, or greater than 2.5 T (Step 212) and so a depression D′, is tentatively indicated. In order to confirm the detection of the depression D′, the ratio of the last two levels, here L₄ and L₃ are compared (Step 212) and if the ratio of L₄ to L₃ is greater than 1.5 the tentative detection of the depression D′ is confirmed (Step 212). The range is calculated as the speed of sound times the time of the last detected pulse, here t₄ (minus any time corresponding to any range offset, R_{OS}) (Step 214). Other embodiments are within the spirit and scope of the appended claims.

What is claimed is:

1. A system, comprising:
a transmitting transducer for transmitting a burst of energy in response to an electrical drive waveform; and
a receiving transducer for generating an electrical signal in response to arrival of the transmitted burst of energy; and
a generator for generating the electrical drive waveform, such generator generating such waveform to enable the receiving transducer to produce the electrical signal with at least one of the following characteristics:
(a) a series of waves having an amplitude which increases, then decreases, and then increases again;
(b) a series of groups of waves, such series having an initial group of waves of a period, T, followed by a transitional group having at least one wave with a period different from the period, T, followed by a succeeding group of waves having the period, T; or
(c) a series of groups of waves, such series having an initial group of waves and a later group of waves, the later group of waves having a phase shift of 2πn relative to the initial group of waves, where n is a non-integer number.

2. The system recited in claim 1 including a detector for detecting one of the characteristics of the electrical signal generated by the receiving transducer.

3. The system recited in claim 1 including a detector for uniquely detecting a specific point in the generated signal, such point being unambiguously identifiable because of the characteristic in the electrical signal generated by the receiving transducer.

4. The system recited in claim 3 wherein the specific point identified by the detector is one of the following:
(a) a specific identifiable positive or negative peak in the electrical signal generated by the receiving transducer;
(b) a zero-crossing point immediately following the identifiable peak; or
(c) another peak or zero-crossing point lying approximately a predetermined time before, or after, the peak or point of (a) or (b), respectively.

5. The system recited in claim 4 wherein the specific identifiable peak is identified on the basis of amplitude relative to the amplitude of one or more preceding peaks or valleys.

6. The system recited in claim 4 wherein the specific identifiable peak is identified on the basis of its phase relative to the phase of one or more peaks or zero-crossings.

7. The system recited in claim 5 wherein the identified peak is the first peak following a depression to have an amplitude greater than a predetermined amplitude relative to the largest peak before the depression.

8. A system for detecting a burst of ultrasonic energy, comprising:
a resonant, acoustic transmitter;
a drive for driving the transmitter with a waveform having a non-periodic feature therein, such transmitter, in response to the drive, being adapted to emit the burst of oscillatory ultrasonic energy;
a receiver for receiving the transmitted burst, the received burst having the non-periodic feature of the waveform driving the transmitter; and
a detector for detecting the non-periodic feature in the received burst.

9. A system for detecting a burst of ultrasonic energy, comprising:
an acoustic transmitter;
a drive for driving he transmitter with a series of waves, one of the waves in the series having a phase reversal relative to a preceding one of the waves;
a receiver for receiving the transmitted burst of ultrasonic energy and producing a signal in response to the received energy, such signal having a characteristic therein resulting from the phase reversal in the driving waves; and
a detector for detecting the characteristic in the receiver produced signal.

10. A system for detecting a burst of ultrasonic energy, comprising:
an acoustic transmitter;
a drive for driving the transmitter with a series of waves, one of the waves in the series having a phase reversal relative to a preceding one of the waves;
a receiver for receiving the transmitted burst of ultrasonic energy and for producing a signal having an oscillatory waveform with a series of peaks and valleys, such peaks initially increasing, then deceasing, then again increasing to a maximum; and
a detector for detecting the decrease and subsequent increase in the amplitude of the series of peaks, or valleys, in the receiver produced signal.

11. A system for detecting a burst of ultrasonic energy, comprising:
an acoustic transmitter;
a driver for driving the transmitter to produce a burst of energy;
a receiver for receiving the transmitter produced burst of energy and for producing a signal in response to the received burst of energy;
wherein the driver is adapted to drive the transmitted to enable the receiver to produce such signal with a depression at a time therein between commencement of the received burst of energy and a maximum in the receiver produced signal;
a detector for detecting the depression in the receiver produced signal.

12. A system for detecting a burst of ultrasonic energy, comprising:
an acoustic transmitter having a resonant frequency f;
a driver for driving the transmitter with a pair of drive waves each having a time duration 1/f, one of the drive waves being out of phase with the other one of the drive waves, such transmitter, in response to the drive, being adapted to emit a burst of oscillatory ultrasonic energy;
a receiver for receiving the transmitted burst and for producing a signal in response to the received burst, such receiver produced signal having a depression therein between commencement of the received burst and a maximum in the received burst;
a detector for detecting the depression in the received burst.

13. A system for detecting a burst of ultrasonic energy, comprising:
an acoustic transmitter;
a drive for driving the transmitter with a series of waves, one of the waves in the series having half period delay from the preceding wave in the series, the transmitter, in response to the drive, being adapted to emit a burst of ultrasonic energy;
a receiver for receiving the transmitted burst, such received burst being an oscillatory waveform having a series of peaks and valleys, such peaks initially monotonically increasing, then deceasing, then again monotonically increasing to a maximum;
a detector for detecting the decrease and subsequent increase prior to the maximum in the series of peaks in the waveform.

14. A system for detecting an oscillatory wave energy, comprising:
a receiver for receiving such burst of oscillatory wave energy and for producing signal having a series of peaks and valleys, such peaks initially monotonically increasing, then deceasing, then again monotonically increasing to a maximum;
a detector for detecting the decrease and increase prior to the maximum in the series of peaks in the receiver produced signal.

15. A system for detecting a burst of wave energy, comprising:
a transmitter for transmitting a burst of wave energy in response to a trigger signal, such transmitted energy being oscillatory and having a phase reversal therein and;
a receiver for receiving the burst;
a detector for a phase reversal in the received burst.

16. A method for detecting a burst of wave energy, comprising:
transmitting the energy as a waveform with a phase reversal therein; and
receiving the transmitted waveform;
detecting a phase reversal in the received waveform.

17. A system for detecting a sound burst, comprising:
a microphone for receiving the sound burst; and
a detector fed by the microphone for detecting a phase reversal in the sound burst received by the microphone.

18. A system for detecting a sound burst, comprising:
an emitter for producing the sound burst with a phase reversal therein;
a microphone for receiving the sound burst; and,
a detector fed by the microphone for detecting the phase reversal in the sound burst received by the microphone.

19. A method for detecting a sound burst, comprising:
transmitting the sound burst with a phase reversal therein;
receiving the sound burst; and,
detecting a phase reversal in the received sound burst.
